(19) United States
(12) Patent Application Publication
(10) Pub. No.: US 2010/0013429 A1
(43) Pub. Date: Jan. 21, 2010

(54) BATTERY MANAGEMENT SYSTEMS AND METHODS

(75) Inventors: Cheng-Wen Chiang, Taoyuan County (TW); Chiang-Wen Lai, Taoyuan County (TW); Yi-Chen Chen, Taoyuan County (TW); John Lai, Taoyuan County (TW); Yu-Chun Ko, Taoyuan County (TW); Chian-Ping Yeh, Taoyuan County (TW); Pei-Ying Huang, Taoyuan County (TW)

Correspondence Address: QUINTERO LAW OFFICE, PC, 2210 MAIN STREET, SUITE 200, SANTA MONICA, CA, 90405, US

(73) Assignee: NAN YA PCB CORP., TAOYUAN COUNTY (TW)

(21) Appl. No.: 12/343,270

(22) Filed: Dec. 23, 2008

(30) Foreign Application Priority Data
Jul. 18, 2008 (TW) TW97127312

(51) Int. Cl. H02J 7/00

(52) U.S. Cl. 320/101

(57) ABSTRACT

Battery management systems and methods are provided. The system includes an electronic device and a fuel cell module. The electronic device includes a processing module, a first power adapter, a first communication interface, and a rechargeable battery. The fuel cell module includes a second power adapter connected with the first power adapter, a second communication interface connected with the first communication interface, at least one fuel cell, and a control unit. The control unit receives a first status of the rechargeable battery from the electronic device via the processing module, the first communication interface and the second communication interface, and determines whether to charge the rechargeable battery using the fuel cell via the second power adapter and the first power adapter according to the first status.

### CROSS REFERENCE TO RELATED APPLICATIONS

This Application claims priority of Taiwan Patent Application No. 097127312, filed on Jul. 18, 2008, the entirety of which is incorporated by reference herein.

### BACKGROUND OF THE INVENTION

1. Field of the Invention

The disclosure relates generally to battery management systems and methods, and, more particularly to systems and methods that manage rechargeable batteries and fuel cells via existing communication interfaces of an electronic device.

2. Description of the Related Art

With the enhancement of functions and popularization of electronic devices, such as household appliances and portable devices, these devices have become necessities of life. The power for theses devices is always provided by batteries.

Some electronic devices may use the power provided by rechargeable batteries, such as Li-ion batteries. With the rapid development of multimedia information, the battery capacity requested by the electronic devices becomes higher. However, safety issues exist in high-capacity Li-ion batteries, resulting in a development bottleneck of Li-ion batteries.

Fuel cells could be used in widespread use. For example, house backup power systems, power systems for vehicles, such as cars or ships, and low-power portable devices can use fuel cells. However, fuel cells are not popularly used in various devices and applications. Since fuel cells are more safety than high-capacity Li-ion batteries, fuel cells may replace Li-ion batteries to become a main power source of new-generation electronic devices.

For example, a SMBus (System Management Bus) can be used as a communication interface between a battery and a computer in notebooks. The SMBus defines some specific addresses for a smart battery system, a smart battery charger, and others. However, since fuel cells are not the main power source, the SMBus does not define related addresses for the fuel cells. If the notebook wants to adopt the fuel cells as another power source, the system circuits must be modified to add corresponding addresses for fuel cells into the SMBus. Since the modification of system circuits involves communications between various system components and related institutions of specifications, it is complex, and may reduce the system stability. If the system circuits are not modified, the fuel cells can only perform the general charge behavior. No information regarding the batteries in the notebook can be obtained, and no related management can be performed.

### BRIEF SUMMARY OF THE INVENTION

Battery management systems and methods are provided.

An embodiment of a battery management system comprises an electronic device and a fuel cell module. The electronic device comprises a processing module, a first power adapter, a first communication interface, and a rechargeable battery. The fuel cell module comprises a second power adapter connected with the first power adapter, a second communication interface connected with the first communication interface, at least one fuel cell, and a control unit. The control unit receives a first status of the rechargeable battery from the electronic device via the processing module, the first communication interface and the second communication interface, and determines whether to charge the rechargeable battery using the fuel cell via the second power adapter and the first power adapter according to the first status.

In an embodiment of a battery management method for use in an electronic device comprising a processing module, a first power adapter, a first communication interface, and a rechargeable battery, a fuel cell module is provided. The fuel cell module comprises a second power adapter connected with the first power adapter, a second communication interface connected with the first communication interface, and at least one fuel cell. The fuel cell module receives a first status of the rechargeable battery from the electronic device via the processing module, the first communication interface and the second communication interface. Then, it is determined whether to charge the rechargeable battery using the fuel cell via the second power adapter and the first power adapter according to the first status.

Battery management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a battery management system of the invention;

FIG. 2 is a flowchart of an embodiment of a battery management method of the invention;

FIG. 3 is a flowchart of an embodiment of a method to determine whether to charge a rechargeable battery using a fuel cell according to a status of the rechargeable battery of the invention;

FIG. 4 is a flowchart of an embodiment of a method to determine whether to charge a rechargeable battery using a fuel cell and/or directly use power of the fuel cell according to statuses of the rechargeable battery and the fuel cell of the invention; and

FIG. 5 is a flowchart of an embodiment of a method to display statuses and/or notifications of a rechargeable battery and/or a fuel cell of the invention.

### DETAILED DESCRIPTION OF THE INVENTION

Battery management systems and methods are provided.

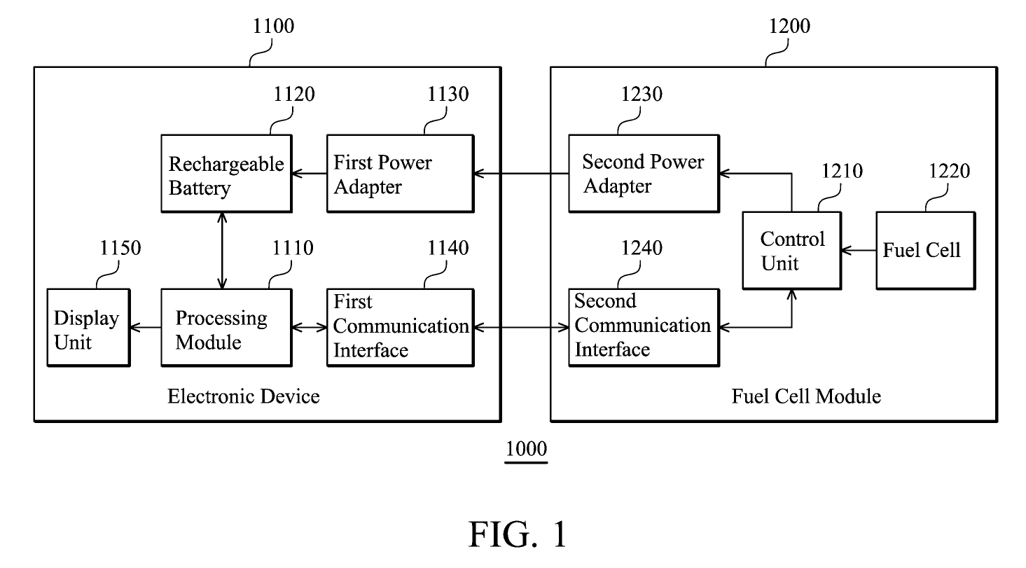

FIG. 1 is a schematic diagram illustrating an embodiment of a battery management system of the invention.

The battery management system 1000 comprises an electronic device 1100 and a fuel cell module 1200. The electronic device 1100 comprises a processing module 1110, a rechargeable battery 1120, a first power adapter 1130, a first communication interface 1140, and a display unit 1150. The electronic device 1100 may be a processor-based device, such as a portable device comprising a notebook, a PDA, a handheld game console, and a mobile phone. It is understood that, any electronic device having a rechargeable battery can be used in the invention. The processing module 1110 may be a BIOS (Basic Input/Output System) and/or CPU (Central Processing Unit) of the electronic device 1100 to retrieve the status of the rechargeable battery 1120, and perform related management. The rechargeable battery 1120 is a battery that can be repeatedly charged, such as a Li-ion battery, to provide power required by the electronic device 1100. The first power adapter 1130 can receive an external power source, such as a power line to directly provide power to the electronic device 1100 and/or charge the rechargeable battery 1120. The first communication interface 1140 is used to communicate with an external device. In some embodiments, the first communication interface 1140 may comprise a USB (Universal Serial Bus), an interface conforming to IEEE (Institute of Electrical and Electronic Engineers) 1394, a SDIO (Secure Digital Input Output) interface, a RS-232 interface, a RS-422 interface, a RS-485 interface, a Bluetooth interface, an infrared interface, and a RF (Radio Frequency) interface. The display unit 1150 can receive instructions from the processing module 1110 to display related information.

The fuel cell module 1200 comprises a control unit 1210, at least one fuel cell 1220, a second power adapter 1230, and a second communication interface 1240. The control unit 1210 can obtain the status of the fuel cell 1220 and/or the rechargeable battery 1120, and perform the battery management methods of the invention accordingly. The second power adapter 1230 is used to connect with the first power adapter 1130 of the electronic device 1100 to transmit the power of the fuel cell 1220 to the electronic device 1100. The second communication interface 1240 is used to connect with the first communication interface 1140 of the electronic device 1100 to transmit related information between the electronic device 1100 and the fuel cell module 1200. Similarly, in some embodiments, the second communication interface 1240 may comprise a USB, an interface conforming to IEEE 1394, a SDIO interface, a RS-232 interface, a RS-422 interface, a RS-485 interface, a Bluetooth interface, an infrared interface, and a RF interface.

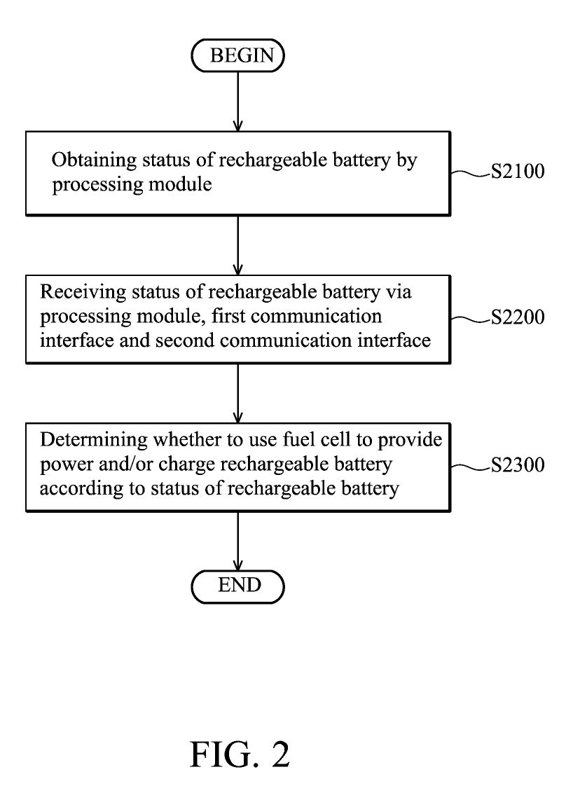

FIG. 2 is a flowchart of an embodiment of a battery management method of the invention.

In step S2100, the processing module 1110 of the electronic device 1100 obtains the status of the rechargeable battery 1120. It is understood that, in some embodiments, the status of the rechargeable battery 1120 may be the remnant power of the rechargeable battery 1120. In step S2200, the control unit 1210 of the fuel cell module 1200 receives the status of the rechargeable battery 1120 from the electronic device 1100 via the processing module 1100, the first communication interface 1140 and the second communication interface 1240. In step S2300, it is determined whether to directly provide power required by the electronic device 1100 using the fuel cell 1220 and/or charge the rechargeable battery 1120 using the fuel cell 1220.

Followings are embodiments of determination whether to directly provide power required by the electronic device 1100 using the fuel cell 1220 and/or charge the rechargeable battery 1120 using the fuel cell 1220.

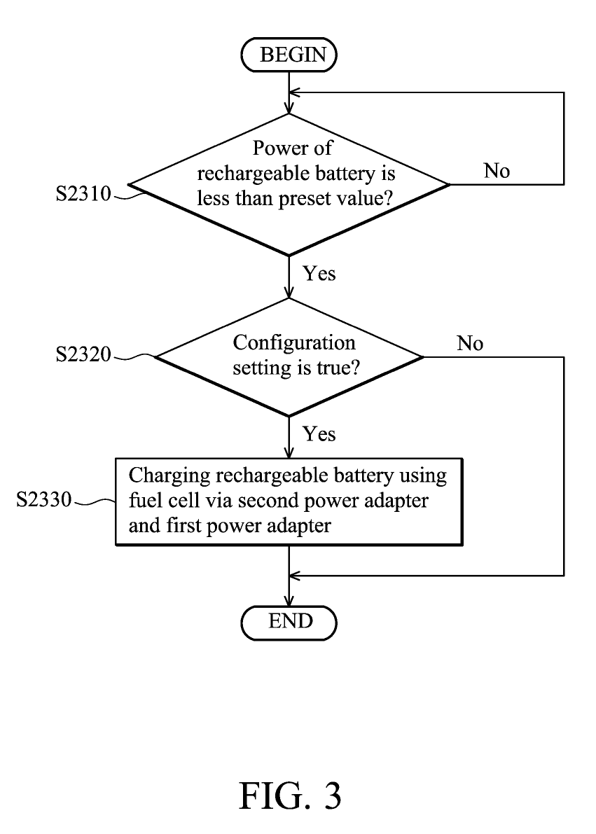

FIG. 3 is a flowchart of an embodiment of a method to determine whether to charge a rechargeable battery using a fuel cell according to a status of the rechargeable battery of the invention.

In step S2310, it is determined whether the power of the rechargeable battery 1120 is less than a preset value. It is understood that, the preset value of charge beginning threshold can be set in the system. When the power of the rechargeable battery 1120 is less than the preset value, the rechargeable battery 1120 needs to be charged. If the power of the rechargeable battery 1120 is not less than the preset value (No in step S2310), the procedure remains at step S2310. If the power of the rechargeable battery 1120 is less than the preset value (Yes in step S2310), in step S2320, it is determined whether a configuration setting is “true”. It is noted that, the configuration setting can be preset in the system. The configuration setting represents whether the rechargeable battery 1120 is expected to charge. In some embodiments, when the configuration setting is “true”, it means the rechargeable battery 1120 is expected to charge. When the configuration setting is “false”, it means the rechargeable battery 1120 is not expected to charge. When the configuration setting is not “true” (No in step S2320), the procedure is completed. When the configuration setting is “true” (Yes in step S2320), in step S2330, the rechargeable battery 1120 is charged using the fuel cell 1220 via the second power adapter 1230 and the first power adapter 1130.

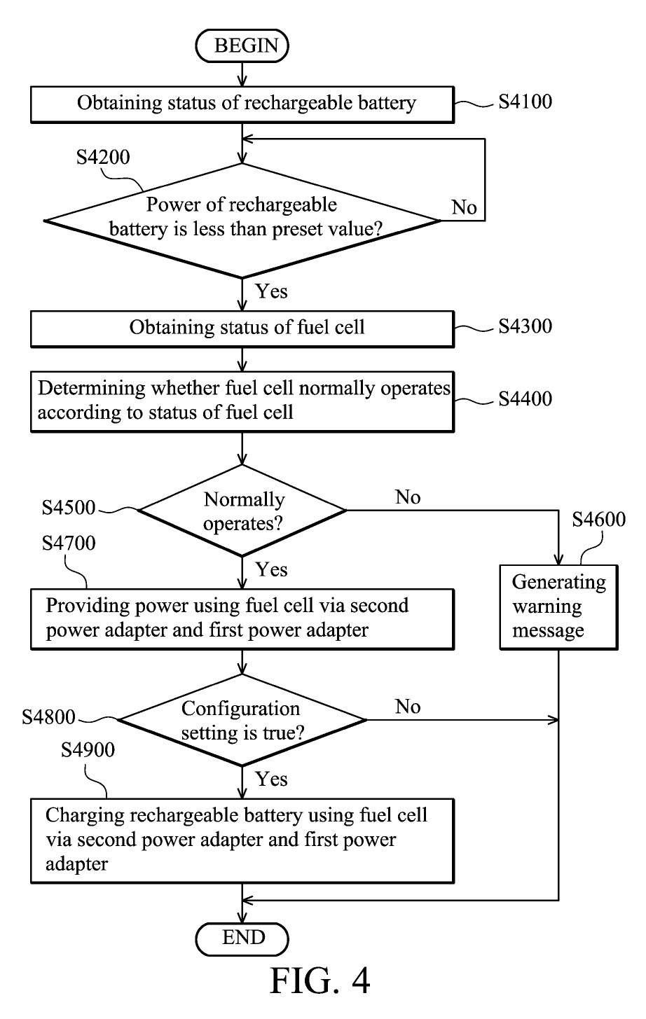

FIG. 4 is a flowchart of an embodiment of a method to determine whether to charge a rechargeable battery using a fuel cell and/or directly use power of the fuel cell according to statuses of the rechargeable battery and the fuel cell of the invention.

In step S4100, the control unit 1210 of the fuel cell module 1200 obtains the status of the rechargeable battery 1120 from the electronic device via the processing module 1100, the first communication interface 1140 and the second communication interface 1240. In step S4200, it is determined whether the power of the rechargeable battery 1120 is less than a preset value according to the status of the rechargeable battery 1120. If the power of the rechargeable battery 1120 is not less than the preset value (No in step S4200), the procedure remains at step S4200. If the power of the rechargeable battery 1120 is less than the preset value (Yes in step S4200), in step S4300, the status of the fuel cell 1220 is obtained. It is understood that, in some embodiments, the status of the fuel cell 1220 may be a temperature of the fuel cell 1220, a remnant time for use of the fuel cell 1220, a fuel concentration of the fuel cell 1220, and/or fuel volume of the fuel cell 1220. In S4400, it is determined whether the fuel cell 1220 normally operates according to the status of the fuel cell 1220. In some embodiments, the determination of whether the fuel cell 1220 normally operates can be performed by determining whether the temperature of the fuel cell 1220 is less than a predefined temperature, determining whether the remnant time for use of the fuel cell 1220 exceeds a predefined time, determining whether the fuel concentration of the fuel cell 1220 is greater than a predefined concentration, and/or determining whether the fuel volume of the fuel cell 1220 exceeds a predefined volume. If the fuel cell 1220 does not normally operate (No in step S4500), in step S4600, a warning message is generated, and the procedure is completed. In some embodiments, the generated warning message can be transmitted from the control unit 1210 of the fuel cell module 1200 to the processing module 1110 of the electronic device 1100 via the second communication interface 1240 and the first communication interface 1140. The processing module 1110 can display the received warning message via the display unit 1150. In some embodiments, the warning message may prompt users that the statuses of the rechargeable battery 1120 and the fuel cell 1220 are both abnormal, and ask users to connect with a power line to provide power to the electronic device 1100 and/or charge the rechargeable battery 1120. If the fuel cell 1220 normally operates (Yes in step S4500), in step S4700, the power of the fuel cell 1220 is provided to the electronic device 1100 via the second power adapter 1230 and the first power adapter 1130. In step S4800, it is determined whether a configuration setting is “true”. Similarly, the configuration setting can be preset in the system. The configuration setting represents whether the rechargeable battery 1120 is expected to charge. In some embodiments, when the configuration setting is “true”, it means the rechargeable battery 1120 is expected to charge. When the configuration setting is “false”, it means the rechargeable battery 1120 is not expected to charge. When the configuration setting is not “true” (No in step S4800), the procedure is completed. When the configuration setting is “true” (Yes in step S4800), in step S4900, the rechargeable battery 1120 is charged using the fuel cell 1220 via the second power adapter 1230 and the first power adapter 1130.

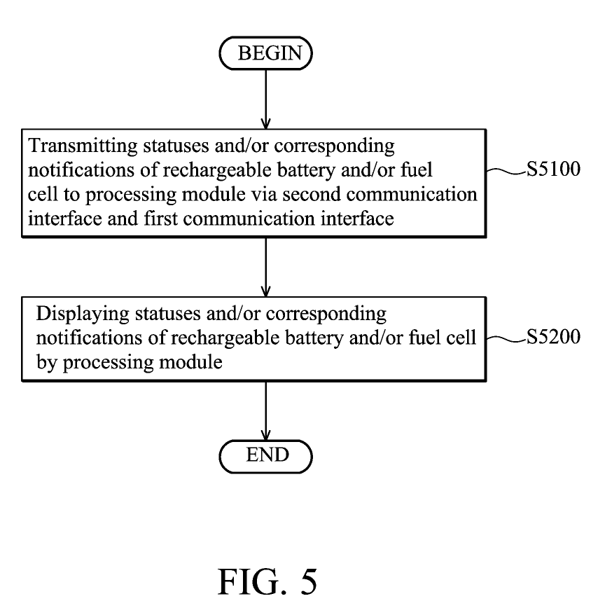

In some embodiments, the statuses of the rechargeable battery 1120 and/or the fuel cell 1220 and/or corresponding notifications can be displayed. FIG. 5 is a flowchart of an embodiment of a method to display statuses and/or notifications of a rechargeable battery and/or a fuel cell of the invention.

In step S5100, the statuses and/or corresponding notifications of the rechargeable battery 1120 and/or the fuel cell 1220 is transmitted from the control unit 1210 of the fuel cell module 1200 to the processing module 1110 of the electronic device 1100 via the second communication interface 1240 and the first communication interface 1140. It is understood that, in some embodiments, the control unit 1210 can perform related determinations according to the statuses of the rechargeable battery 1120 and/or the fuel cell 1220, and generate corresponding notifications. For example, when the power of the rechargeable battery 1120 is less than a predefined threshold, a message notifying the rechargeable battery 1120 is at a low-power state is generated. In step S5200, the processing module 1110 displays the received statuses and/or corresponding notifications of the rechargeable battery 1120 and/or the fuel cell 1220 via the display unit 1150. It is noted that, in the above embodiments, the information are displayed via the display unit 1150. However, in some embodiments, various notification manners can be preset in the system. In some embodiments, the notifications can be prompted via display and/or audio. Additionally, in some embodiments, the notifications can be only recorded in the system, and no prompt is generated.

Since the first communication interface is an existing communication interface of the electronic device, the battery management systems and methods of the application can manage rechargeable batteries and fuel cells via existing communication interfaces without any modification of system circuits.

Battery management methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A battery management system, comprising:
an electronic device, comprising:
a processing module;
a first power adapter;
a first communication interface; and
a rechargeable battery; and
a fuel cell module, comprising:
a second power adapter connected with the first power adapter;
a second communication interface connected with the first communication interface;
at least one fuel cell; and
a control unit receiving a first status of the rechargeable battery from the electronic device via the processing module, the first communication interface and the second communication interface, and determining whether to charge the rechargeable battery using the fuel cell via the second power adapter and the first power adapter according to the first status.

2. The system of claim 1, wherein the control unit determines whether a power of the rechargeable battery is less than a preset value according to the first status, and when the power of the rechargeable battery is less than the preset value, charges the rechargeable battery using the fuel cell via the second power adapter and the first power adapter.

3. The system of claim 2, wherein the control unit further determines whether to charge the rechargeable battery according to a configuration setting.

4. The system of claim 2, wherein the control unit further obtains a second status of the fuel cell, determines whether the fuel cell normally operates according to the second status, and when the fuel cell normally operates, charges the rechargeable battery using the fuel cell via the second power adapter and the first power adapter.

5. The system of claim 4, wherein the control unit determines whether the fuel cell normally operates by determining whether a temperature of the fuel cell is less than a predefined temperature, determining whether a remnant time for use of the fuel cell exceeds a predefined time, determining whether a fuel concentration of the fuel cell is greater than a predefined concentration, or determining whether a fuel volume of the fuel cell exceeds a predefined volume.

6. The system of claim 1, wherein the control unit determines whether a power of the rechargeable battery is less than a preset value according to the first status, when the power of the rechargeable battery is less than the preset value, obtains a second status of the fuel cell, determines whether the fuel cell normally operates according to the second status, and when the fuel cell normally operates, charges the rechargeable battery using the fuel cell via the second power adapter and the first power adapter.

7. The system of claim 6, wherein the control unit further determines whether to charge the rechargeable battery using the fuel cell via the second power adapter and the first power adapter according to a configuration setting during the fuel cell provides power to the electronic device.

8. The system of claim 1, wherein the control unit further obtains a second status of the fuel cell, and transmits the second status or a notification corresponding to the second status to the processing module of the electronic device via the second communication interface and the first communication interface, and the processing module displays the second status or the notification corresponding to the second status via a display unit.

9. The system of claim 1, wherein the control unit further transmits the first status or a notification corresponding to the first status to the processing module of the electronic device via the second communication interface and the first communication interface, and the processing module displays the first status or the notification corresponding to the first status via a display unit.

10. The system of claim 1, wherein the processing module comprises a BIOS (Basic Input/Output System).

11. The system of claim 1, wherein the first communication interface comprises a USB (Universal Serial Bus), an interface conforming to IEEE (Institute of Electrical and Electronic Engineers) 1394, a SDIO (Secure Digital Input Output) interface, a RS-232 interface, a RS-422 interface, a RS-485 interface, a Bluetooth interface, an infrared interface, or a RF (Radio Frequency) interface.

12. A battery management method for use in an electronic device comprising a processing module, a first power adapter, a first communication interface, and a rechargeable battery, the method comprising:
providing a fuel cell module, wherein the fuel cell module comprises a second power adapter connected with the first power adapter, a second communication interface connected with the first communication interface, and at least one fuel cell;
receiving a first status of the rechargeable battery from the electronic device via the processing module, the first communication interface and the second communication interface by the fuel cell module; and
determining whether to charge the rechargeable battery using the fuel cell via the second power adapter and the first power adapter according to the first status.

13. The method of claim 12, further comprising:
determining whether a power of the rechargeable battery is less than a preset value according to the first status; and
when the power of the rechargeable battery is less than the preset value, charging the rechargeable battery using the fuel cell via the second power adapter and the first power adapter.

14. The method of claim 13, further comprising determining whether to charge the rechargeable battery according to a configuration setting.

15. The method of claim 13, further comprising:
obtaining a second status of the fuel cell;
determining whether the fuel cell normally operates according to the second status; and
when the fuel cell normally operates, charging the rechargeable battery using the fuel cell via the second power adapter and the first power adapter.

16. The method of claim 15, wherein the determination of whether the fuel cell normally operates is performed by determining whether a temperature of the fuel cell is less than a predefined temperature, determining whether a remnant time for use of the fuel cell exceeds a predefined time, determining whether a fuel concentration of the fuel cell is greater than a predefined concentration, or determining whether a fuel volume of the fuel cell exceeds a predefined volume.

17. The method of claim 12, further comprising:
determining whether a power of the rechargeable battery is less than a preset value according to the first status;
when the power of the rechargeable battery is less than the preset value, obtaining a second status of the fuel cell;
determining whether the fuel cell normally operates according to the second status; and
when the fuel cell normally operates, charging the rechargeable battery using the fuel cell via the second power adapter and the first power adapter.

18. The method of claim 17, further comprising determining whether to charge the rechargeable battery using the fuel cell via the second power adapter and the first power adapter according to a configuration setting during the fuel cell provides power to the electronic device.

19. The method of claim 12, further comprising:
obtaining a second status of the fuel cell;
transmitting the second status or a notification corresponding to the second status to the processing module of the electronic device via the second communication interface and the first communication interface; and
displaying the second status or the notification corresponding to the second status via a display unit by the processing module.

20. The method of claim 12, further comprising: transmitting the first status or a notification corresponding to the first status to the processing module of the electronic device via the second communication interface and the first communication interface; and
displaying the first status or the notification corresponding to the first status via a display unit by the processing module.

21. The method of claim 12, wherein the processing module comprises a BIOS (Basic Input/Output System).

22. The method of claim 12, wherein the first communication interface comprises a USB (Universal Serial Bus), an interface conforming to IEEE (Institute of Electrical and Electronic Engineers) 1394, a SDIO (Secure Digital Input Output) interface, a RS-232 interface, a RS-422 interface, a RS-485 interface, a Bluetooth interface, an infrared interface, or a RF (Radio Frequency) interface.
